(19) United States
(12) Patent Application Publication
(10) Pub. No.: US 2019/0156394 A1
(43) Pub. Date: May 23, 2019

(54) Distributed Sensor Systems and Methods for Inventory Control

(71) Applicant: Walmart Apollo, LLC, Bentonville, AR (US)

(72) Inventor: Somedip Karmakar, Kolkata (IN)

(21) Appl. No.: 15/890,999

(22) Filed: Feb. 7, 2018

(30) Foreign Application Priority Data
Nov. 18, 2017 (IN) 201711041325

(51) Int. Cl. G06Q 30/06; G06Q 10/08

(52) U.S. Cl. CPC G06Q 30/0631; G06K 7/10366; G06Q 10/087

(57) ABSTRACT

A system and method to identify which products are viewed by a user before making a purchase decision and also identify the products considered most before ultimately purchasing. The system uses sensors placed on the shelves to identify the item viewed before making a purchase decision and also track the time spent per decision. The tracking allows viewed and ultimately bought scores and item similarity scores to be determined. The scores are used by the system to identify suitable substitutes and complement items and understand the key attributes in making purchase decisions. The scoring identifies better item assortment decision and pricing, which in turn can increase the revenue of retail stores.

### RELATED APPLICATIONS

This application claims priority to Indian Patent Application No. 201711041325 entitled “DISTRIBUTED SENSOR SYSTEMS AND METHODS FOR INVENTORY CONTROL,” filed on Nov. 18, 2017, the content of which is hereby incorporated by reference in its entirety.

### BACKGROUND

The shopping pattern and buying behavior of users on e-commerce websites can be understood. For example, session tracking can be used to track when similar items are viewed on the websites and tracking which items are ultimately purchased. Viewed and ultimately bought (VUB) scores can be generated based on this online tracking and can be used to determine suitable substitute, similar, or complementary items to the item that is ultimately purchased.

Unlike in online tracking, tracking of user actions in physical stores can be difficult and analogues to the VUB scores are typically unavailable at a retail store level.

### BRIEF DESCRIPTION OF DRAWINGS

Illustrative embodiments are shown by way of example in the accompanying drawings and should not be considered as a limitation of the present disclosure:

FIG. 1 is a block diagram illustrating a distributed sensor system according to an exemplary embodiment.

FIG. 2 is diagram illustrating a deployment of an array of sensor modules in the distributed sensor system according to an exemplary embodiment.

FIG. 3 is a diagram illustrating a deployment of an array of sensor modules in a shelving unit according to an exemplary embodiment.

FIG. 4 is a flowchart illustrating a process implemented by the distributed sensor system for determining continuous detection of a user according to an exemplary embodiment.

FIG. 5 is a flowchart illustrating a process implemented the distributed sensor system for modifying inventory records based on sensor outputs according to an exemplary embodiment.

FIG. 6 is a flowchart illustrating a process for updating inventory records according to an exemplary embodiment.

FIG. 7 is a block diagram illustrating an electronic device operable to support the distributed sensor system according to an exemplary embodiment.

FIG. 8 is a block diagram of an example sensor module to support the distributed sensor system according to an exemplary embodiment.

### DETAILED DESCRIPTION

Described in detail herein is a distributed sensor system for inventory control and management. Embodiments of the system can detect and identify which products are being viewed by a user before the makes a purchase decision, can detect and identify the products considered most before purchasing ultimately a specified product, and/or can detect and identify which products are viewed but not purchased. Additionally, embodiments of the system can utilize the detected and identified data to predictively manage and control inventor of the products.

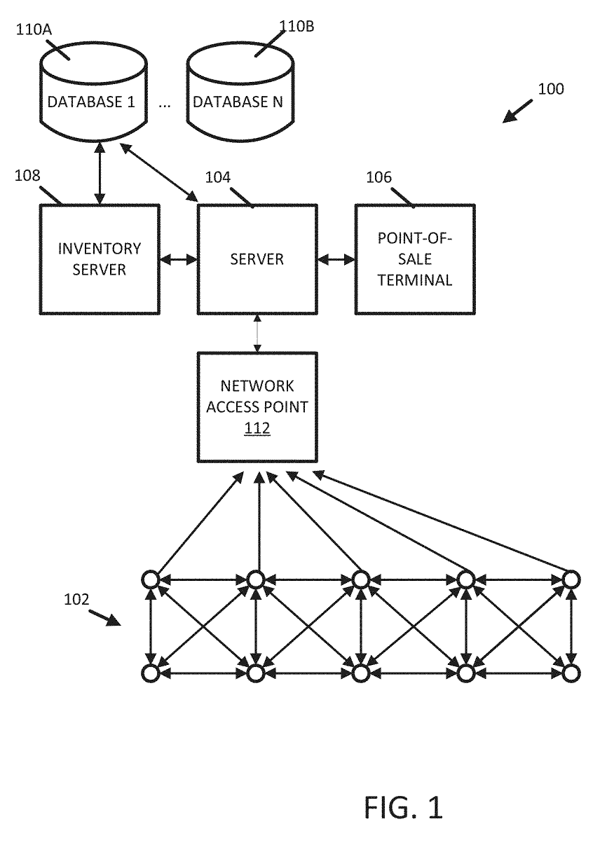

FIG. 1 is a block diagram illustrating a distributed sensor system 100 for controlling and managing inventory according to an exemplary embodiment. Embodiments of the system 100 can include an array of sensor modules 102, servers 104 and 108, one or more point-of-sale terminals 106, databases 110A, 110B, and at least one network access point 112.

Each sensor module in the array of sensor modules 102 can be considered a node and each sensor module in the array 102 can be in selective communication with adjacent or neighboring nodes in the array. The sensor modules can communicate with adjacent or neighboring nodes through wired and/or wireless communication. Communication support to facilitate communication between adjacent nodes in the array of sensors can include Bluetooth®, Zigbee, WiFi (e.g., as specified by IEEE 802.11a-n), near-field communications (NFC) or other comparable wireless communication stacks. Additionally, the array of sensors 102 can be implemented within an Internet of Things framework such as ioTivity or Zephyr, which support a development stack with underlying communication application programming interfaces (APIs) already implemented. The array of sensor modules 102 can be implemented with sensing elements such as optical sensors, acoustic sensors, weight sensors, radio-frequency identification (RFID), inductance sensors, capacitive sensors, cameras (e.g., CMOS imagers or CCD sensors) or a combination of these sensors.

The array of sensor modules 102 can be in selective communication with the server 104 via the network access point. The network access point is an electronic device that provides the sensor modules access to a network including the server 104. The network access point can route or relay data communications between devices in a network (e.g., between the sensor modules and the server 104). In exemplary embodiments of the network access point can be embodied as a relay, a router, a gateway, a hub, a server, a modem, or any other device suitable for facilitating connection of the sensor modules to the network and routing data communications between devices on the network. As a non-limiting example, the network access point can be a WiFi access point.

The server 104 receives data from the array of sensors modules 102 via the network access point 112. The data can include information relating to the placement/location of the sensor module(s) transmitting the data, information regarding objects detected by the sensor module(s), and other relevant data corresponding to the type of sensor(s) implemented by the sensor module(s) (e.g., images from an optical sensors, weights measurements from a weight sensor, data from an IR or acoustic sensor, etc.). The server 104 utilizes the data from the array of sensor modules 102 to determine user interest in an item placed near to the sensor. The server 104 can also determine attributes of items selected or, alternatively, not selected by a user, and provide recommendations on item placement to improve the likelihood of an item being selected

The one or more point of sale terminals 106 facilitate transactions of viewed and selected items by the users. Point of sale terminals 106 transmit transaction data to the server to provide correlative data between items viewed by a user, time spent viewing an item by a user, and the purchasing of an item by a user.

The server 108 can be an inventory server that manages interaction between inventory and product databases 110A, 110B. The inventory server 108 can also facilitate any inventory replenishment activities as well. The inventory server 108 can be a logically separate entity from the server 104 and the databases 110A, 110B, but physically the inventory server 108 can coexist on the same hardware as the server 104. As the inventory server 108 can service other disparate systems, the server 108 can provide additional computational resources to avoid overutilization of the inventory server 108. The server 108 provides the computational resources to decode data from the array of sensor modules 102, as well as interfacing with the point-of-sale terminal 106. To minimize computational burden on the inventory server 108, the server 104 only interfaces with the inventory server when information inventory or product information is necessary for the process.

The databases 110A, 110B can include rows or records corresponding to items in a facility, items of interest being viewed and/or selected by users, items being monitored by the array of sensor modules 102. The inventory server 108 provides an interface for accessing the databases 110A, 110B. As the inventory databases 110A, 110B can be accessed by other disparate systems, the inventory server 108 can provide support for all query requests for the database. The inventory server 108 can queue query requests to mitigate database 110A, 110B query overloads. At least some of the records can be generated on a set interval to display trends relating to the items being analyzed by the array of sensor modules 102. The databases 110A, 110B can include records corresponding to past item purchase history and trends. Additionally the databases 110A, 110B can include latent attributes corresponding to each item in the databases 110A, 110B where each latent attribute corresponds to a characteristic of the product. Like the inventory server 108, the databases 110A, 110B can be logical instances of databases, and can physically reside on the server 104.

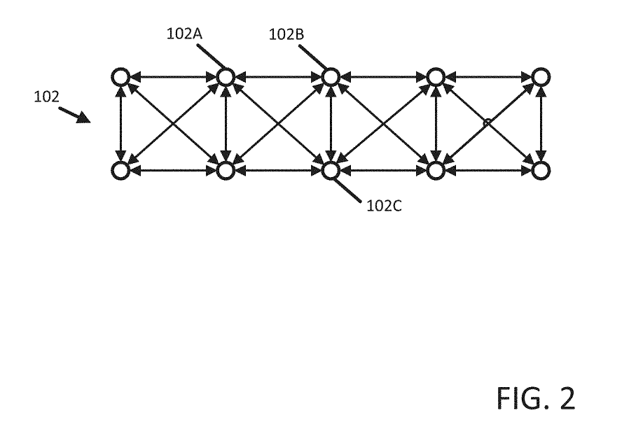

FIG. 2 is diagram illustrating the deployment of an embodiment of the array of sensors 102 in a retail environment according to an exemplary embodiment. In the present example embodiments, the sensor modules in the array of sensor modules 102 can wirelessly communicate with adjacent/neighboring sensor modules. As mentioned above the array of sensor modules 102 can utilize one or more wireless communication stacks or protocols.

Each of the sensor modules in the array 102 can have three modes of operation based on object detection by the sensor in each sensor module and/or based on the object detection by the sensors in one or more adjacent or neighboring sensor modules. As one example each sensor module can have sleep state (e.g., a first mode of operation), an active state (e.g., a second mode of operation), and an intermediate state (e.g., a third mode of operation). In exemplary embodiments, each of the sensor modules can normally be in the sleep state of operation (i.e. the default state)

In an exemplary operation, when the sensor of a first sensor module 102A detects an object (e.g., a user standing in front of and within range of the sensor), the first sensor module 102A transitions from the sleep state to the active mode. The first sensor module 102A determines the existence and/or movement of a user based on sensed data output by the sensor. In another embodiment, the first sensor module 102A, transmits the data to the server 104, which determines the existence and/or movement of the user.

In response to the first sensor module detecting the user, the first sensor module transmits a wake message to its adjacent/neighboring sensor modules, which can include a second sensor module 102B as well as other sensor modules. Additionally, or in the alternative, as described herein, the first sensor module can transmit a message to the server 104 (FIG. 1) if the sensor module continuously detects the user for a specified time threshold. In response to the second sensor module 102B receiving the wake message from first sensor module 102A, the second sensor module 102B, transitions from the sleep state to the intermediate state. While the second sensor module 102B is in the intermediate state, the second sensor module 102B recordation of sensing data is enabled in the second sensor module and the wireless transmitter is disabled.

In one example operation, the first the sensor module 102A also transmits sensing data to the server upon continuous detection of the first user within range of the first one of the sensor modules for a period of time that is greater than the threshold time or reverts back to the sleep state upon detection of the user within range of the first one of the sensor modules for a period of time that is less than the threshold time.

Upon detection of the second user by the second sensor module 102B, the second sensor module 102B, transitions from the intermediate state to the active state. The second sensor module transmits a wake message to its adjacent/neighboring sensor modules. Additionally, or in the alternative, as described herein, the first sensor module can transmit a message to the server 104 (FIG. 1) if the sensor module continuously detects the user for a specified time threshold.

As the user moves out of range of the sensor modules in that are in the active state and a specified amount of time has passed, the sensor modules return to the sleep state unless the sensor modules receive a wake message from a neighboring sensor module in which case the sensor module(s) enter the intermediate state.

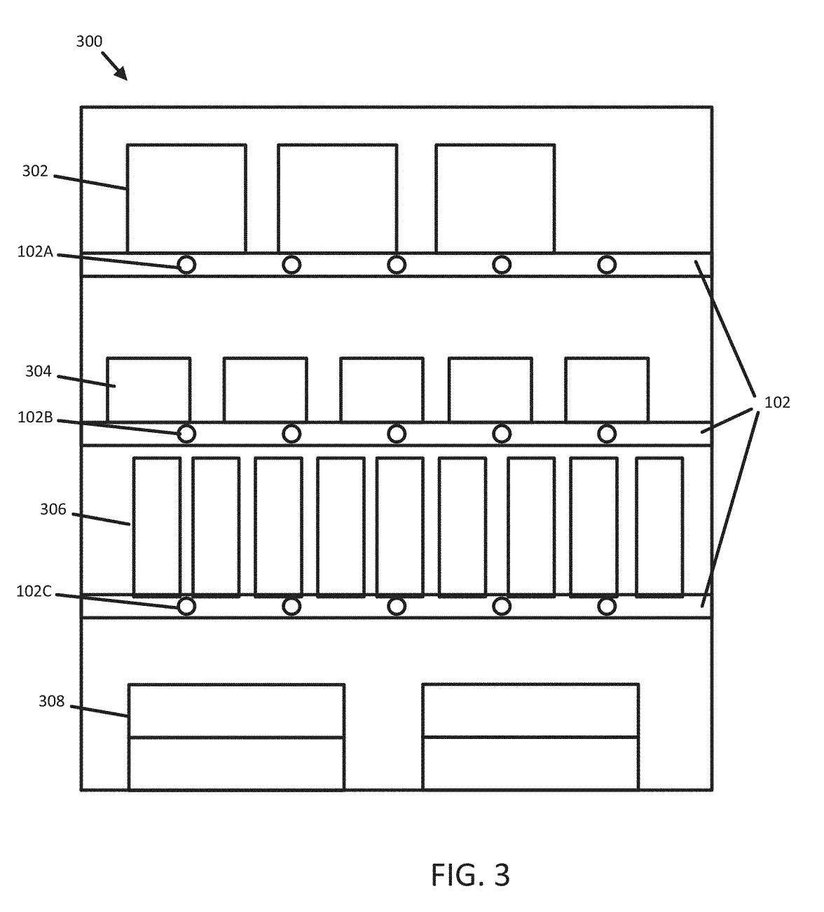

FIG. 3 is a diagram illustrating the deployment of an array of sensor modules in a shelving unit according to an exemplary embodiment.

The deployment of an array of sensor modules 102 can include affixing of each of the array of sensor modules 102 to a shelving unit 300. The array of sensor modules 102 can be deployed on the shelves of the shelving unit 300. Alternatively, the array of sensor modules 102 can be deployed at the top of the shelving unit 300 or the base of the shelving unit 300. The array of sensor modules 102 can be placed correspondingly to different products located on the shelves of the shelving unit 300, where one of the sensor modules in the array of sensor modules 102 corresponds to a specific item stock. Each of the sensors in the array of sensor modules 102 can be spaced by the average dimension of items in a category corresponding to the items.

In this embodiment the first sensor module 102A can be placed correspondingly to a specific item A 302. The first sensor module 102A can detect and transmit any data corresponding to interactions with item A.

The second sensor module 102B can be placed corresponding to a specific item B 304. The second sensor module 102B can detect and transmit any data corresponding to interactions with item B.

The third sensor module 102C can be placed corresponding to a specific item C 306. The second sensor module 102C can detect and transmit any data corresponding to interactions with item C.

In this embodiment, as the user views item A 302, moves to item B 304, and finally to item C 306, each of the sensors in the arrays of sensors 102 changes power states corresponding to the item being observed. In this embodiment, historical data about the item being viewed can be determined by the changing of power states of the modules.

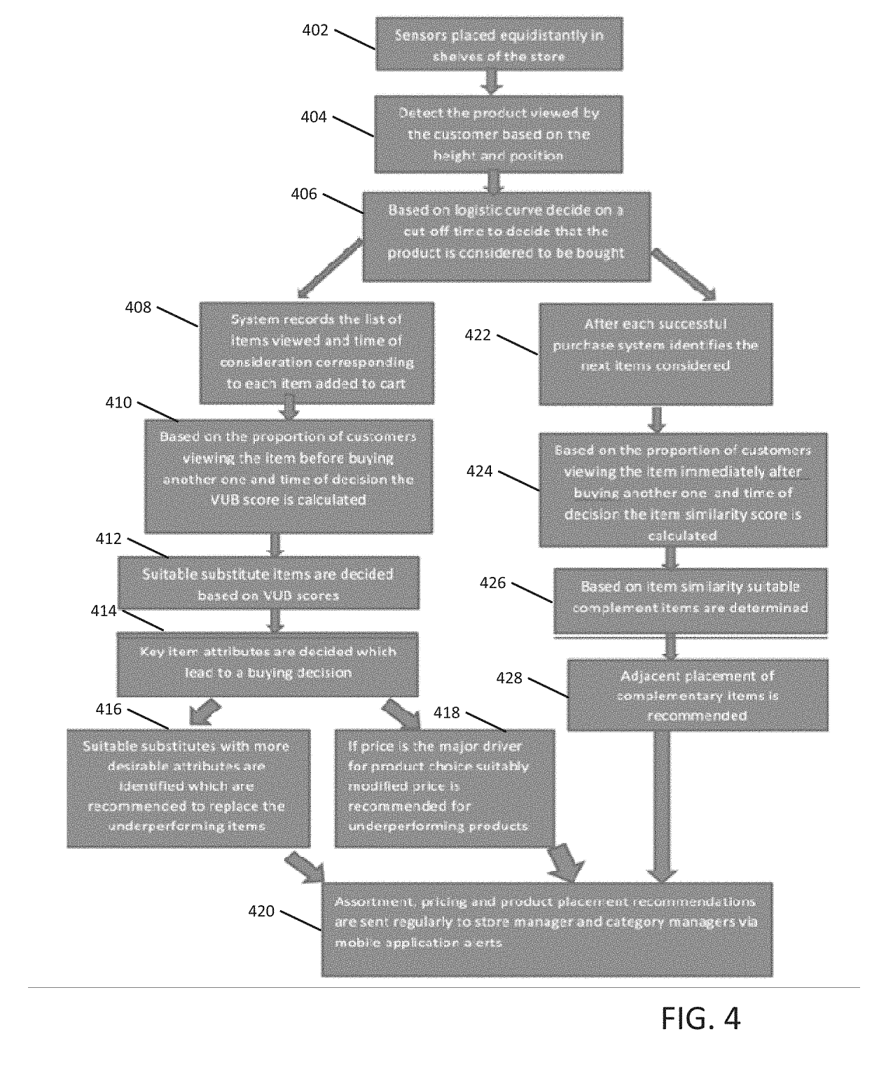

FIG. 4 is a flowchart illustrating a process determining continuous detection of a user according to an exemplary embodiment.

At step 402, sensor modules can be placed equidistantly in shelves of the store. The sensors can be an array of sensors. The sensors can be implemented as optical sensors, acoustic sensors, weight sensors, RFID tags/readers, inductive sensors, capacitive sensors, cameras or a combination of these. The sensors detect and record the amount of time spent by the user in front of the item. The adjacent sensors communicated through Bluetooth, or comparable wireless protocol, to detect and track movement of users from one item to another and to detect double-counting.

At step 404, a product viewed by the user is detected by one or more of the sensor modules based on the height and position. A time spent by a user i in front of an item j can be denoted Tᵢⱼ. Let Yᵢⱼ denote an indicator variable such that: Yᵢⱼ=1, if the user i and purchases the item j. Otherwise Yᵢⱼ=0. Then for the j^{th} item, a logistic regression is performed as follows:

Pᵢⱼ=Probability(Yᵢⱼ=1)

log(Pᵢⱼ/(1−Pᵢⱼ)=α+β*Tᵢⱼ+eᵢⱼ

Pij=1(1+exp(−(α+β*Tᵢⱼ))+eᵢⱼ−1

where eᵢⱼ˜N(0,Σ)

Fitting a least squares solution by minimizing the sum of squares eᵢⱼ, estimated values of the unknown values α and β can be obtained. Utilizing the estimated values of α and β, a predicted value for P_{ij can} be obtained from the observed Tᵢⱼ values.

At step 406, based on logistic curve, a cut-off time can be determined by the sensor module that detected the user or by the server (in response to the sensor module transmitting sensed data to the server) to facilitate a decision indicating that the product is considered to be bought. Starting with an arbitrary cut-off value c₀, if predicted Pᵢⱼ>c₀, then the predicted indicator variable equals one, Yᵢⱼ=1. A sensitivity can be defined as a proportion of times that actual Yᵢⱼ=1. Specificity can then be defined as a proportion of times that actual Yᵢⱼ=0. A plot of specificity and its inverse, e.g., 1-specificity, forms a receiver operation characteristic (ROC) curve.

The area under the curve (AUC) corresponding to all possible values of c₀, (0<c₀<1) can be computed and the optimal value of c₀=c₁ which is the AUC maximum can be selected. Substituting Pij with c₁ and using the estimated values of α and β, the optimal cut-off for Tᵢⱼ can be obtained. The optimal cut-off values are obtained for each item in a category of items available (e.g., on the shelves and/or in a facility) and updated periodically, e.g., at a daily, weekly, monthly, or yearly intervals. When the time spent in front of an item is greater than the optimal value (Tᵢⱼ>c₁) for a given user/item combination is observed, the system can determine that the user is interested in that item.

At step 408, the server records the list of items viewed and time of consideration corresponding to each item added to the cart. The server can store the viewed and time of consideration for each item in the databases 110A, 110B. The databases 110A, 110B can create a row corresponding to the item, where a new row represents a new observed time of consideration corresponding to each item added to the cart.

At step 410, based on the proportion of users viewing the item before buying another one, and time of decision, the sensor module or the server can calculate the viewed and ultimately bought (VUB) score for the item. Based on the past point of sale (POS) sales records and user data recorded by the server, the following can be calculated:

P_{bla}=(number of users who are interested in item b)/(number of users who purchase item a)

T_{bla}=(average time spent by the users who purchase item a, to consider item b)/(average time spent by the users to consider item b)

The VUB score of item b relative to item a is V(bla)=P_{bla}*T_{bla}. Best substitutes of item a are given by those with maximum values of V(bla).

At step 412, the server identifies suitable substituted items based on VUB scores. Best substitutes of item a are given by those with maximum values of V(bla). The list of items considered by a user i immediately after putting item a in the cart can be taken into account. The also bought score (ABS) of item b relative to item a can be determined by dividing the number of users who add item b to the cart after adding item a by the number of users adding item a to the cart (ABS(bla)=(number of users who add item b to the cart after adding item a)/(number of users adding item a to the cart)).

The Also Viewed Score (AVS) of an item b relative to item a can be determined dividing the number of users who are interested in item b after adding item a to cart and before the next addition to cart by the number of users adding item a to cart (AVS(bla)=(number of users who are interested in item b after adding item a to cart and before the next addition to cart)/(number of users adding item a to cart)).

The base item similarity (BIS) score=BIS(bla)=al*ABS(bla)+AVS(bla). al denotes a characteristic based on a proportion of items viewed over items purchased, where al=(average number of items viewed by users after purchasing item A)/(Average number of items purchased by users after purchasing item a). The item similarity score is TIS(bla)=(average time spent by users in viewing item b after purchasing item a)/(average time spent by users in viewing all items after purchasing item a before the next purchase). The item similarity score I of item b relative to item a is I(bla)=BIS(bla)*TIS(bla). Best complements of item a are given by those with maximum values of I(bla).

At step 414, key item attributes are decided by the server based on the VUB scores. Using the VUB scores, the list of best substitutes for each item can be obtained. Latent item attributes like price, weight, pack size, color, flavor, nutrition index can be utilized as attributes depending on the category of items. Utilizing a model V(bla)˜l1,l2, . . . where l1 and l2 are latent attributes, the variable importance score of the Random Forest model, can determine the most important distinguishable attributes L1, L2, L3, etc. A classification model based upon the any sensed data for each item can be used to determine key driver attributes.

At step 416, suitable substitutes with more desirable attributes are identified by the server and are recommended to replace the underperforming items. A list of substitutes can be identified and ordered based on past sales. Comparing important attributes L1, L2, . . . etc. between the highest and lowest selling items can give the causal levels of the important attributes which can cause the variation in item performance. For example, item B1 can be the highest selling good with higher levels of attributes L11, L21, etc. and item B5 can be the lowest selling good with higher attribute levels L15, L25, etc. Low performing items can be substituted by those items which have high VUB scores and the causal levels of important attributes which cause high performances. In the above example item B5 can be substituted with another item, B7, with high attribute levels L11, L21, L35, and L45.

At step 418, if price is the major driver for product choice, suitably modified prices are recommended for underperforming products. If L1=price and the remaining attributes are less important, then decreasing the price of the low performing item can lead to better sales of the item. Items with high similarity scores should be placed adjacently to increase the cross-sales.

At step 420, assortment, pricing and product placement recommendations are generated by the server and sent regularly to store manager and category managers via mobile application alerts.

In parallel to the process described above, at step 422, the server identifies the next items considered after each successful purchase. The server utilizes the next considered items in a feedback loop upon the purchase of an item.

At step 424, based on the proportion of users viewing the item immediately after buying another one, and a time of decision, the item similarity score is calculated by the server. The similarity score is dependent upon the time frame in which the user removes the item from the shelf, places it in the cart, and views another item.

At step 426, based on item similarity, suitable complement items are determined by the server. The items viewed immediately after the removed item, can be used to determine the latent attributes in the suitability scores.

At step 428, adjacent placement of complementary items is recommended by the server.

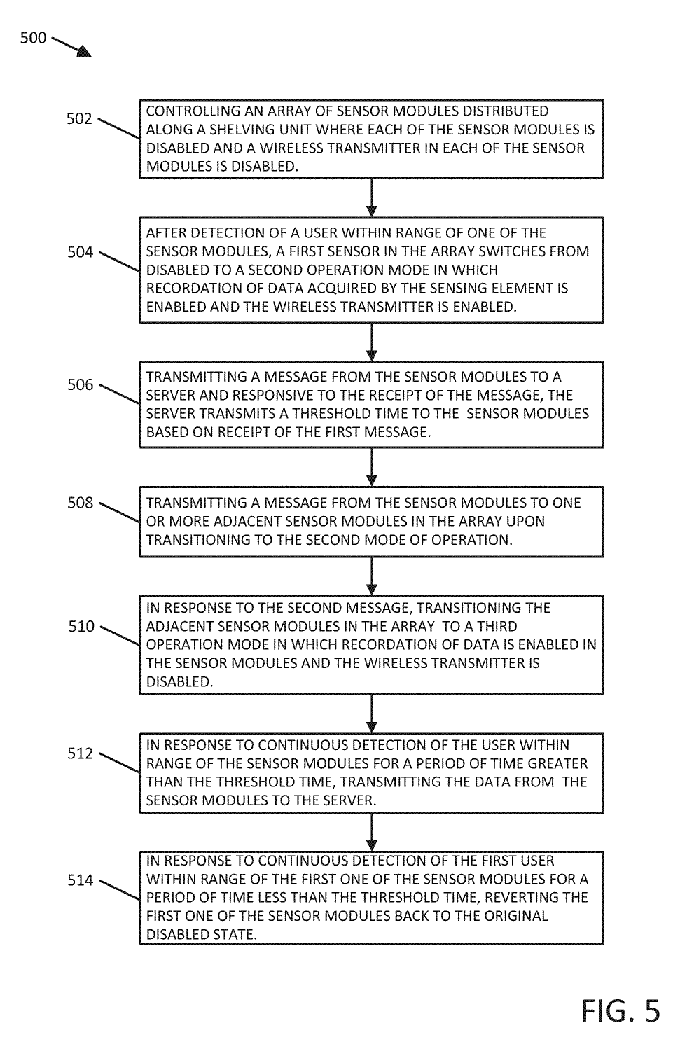

FIG. 5 is a flowchart illustrating a process determining continuous detection of a user according to an exemplary embodiment.

At step 502, an array of sensor modules distributed along a shelving unit in a facility are controlled according to a first operation mode by default in which recordation of sensor data acquired by a sensing element in each of the sensor modules is disabled and a wireless transmitter in each of the sensor modules is disabled. The array of sensor modules, when inactive, exist in a low power state or sleep state.

At step 504, in response to detection of a user within range of a first one of the sensor modules, the first one of the sensor modules in the array transitions from the first operation mode to a second operation mode in which recordation of the sensing data acquired by the sensing element is enabled and the wireless transmitter is enabled. The first sensor modules activates the corresponding sensing element and begins recording data from the sensing element. Additionally, the first user is identified, from the sensing data, removing at least one or more of the items from the shelving unit. A preference score is calculated for each item using the sensing data and whether the user removes the item from the shelving unit.

Additionally, a message request can be transmitted from sensor modules to the server. The server transmits a threshold time to the sensors on receipt of the message request. Another message can be transmitted from the sensor modules to the first one of the sensor modules upon transitioning to the second mode of operation. In response to receipt of the message, the first one of the sensor modules transitions to the third operation mode in which recordation of sensing data is enabled and the wireless transmitter is disabled.

At step 506, a first message is transmitted from the first one of the sensor modules to a server in selective communication with the sensor modules, the server configured to receive the first message from the first one of the sensor modules and to transmit a threshold time to the first one of the sensor modules based on receipt of the first message. The threshold time corresponds to a time long enough in duration to determine that a user is interested in a product located adjacent or near the first one of the sensor modules. The threshold time associated with each item can also be extracted from the sensing data. Based on the preference score, a recommendation is provided to a second user for at least one of the items. The recommendation can include replacing a low-performing item with a different item, rearranging locations of item on the shelving unit or changing the pricing for an item.

At step 508, upon transitioning to the second mode of operation, a second message can be transmitted from the first one of the sensor modules to one or more of the sensor modules in the array that are located adjacent to the first one of the sensor modules. The first one of the sensor modules notifies the adjacent sensor modules of an impending change of state.

At step 510, in response to receipt of the second message, the one or more sensor modules in the array located adjacent to the first one of sensor modules transition to a third operation mode in which recordation of sensing data is enabled in the one or more sensor modules and the wireless transmitter is disabled. The first sensor module notifies the adjacent modules to begin to record sensing data,

At step 512, in response to continuous detection of the first user within range of the first one of the sensor modules for a period of time greater than the threshold time, the sensing data is transmitted from the first one of the sensor modules to the server. Upon the user lingering for the threshold time, the first sensor propagates its recorded data to the server 104.

At step 514, in response to continuous detection of the first user within range of the first one of the sensor modules for a period of time less than the threshold time, the first one of the sensor modules reverts back to the first operation mode. As the user can be transiting in front of the one or more sensor modules, the failure to meet the threshold allows the first one of the sensor modules to revert to a low power, sleep or disabled state.

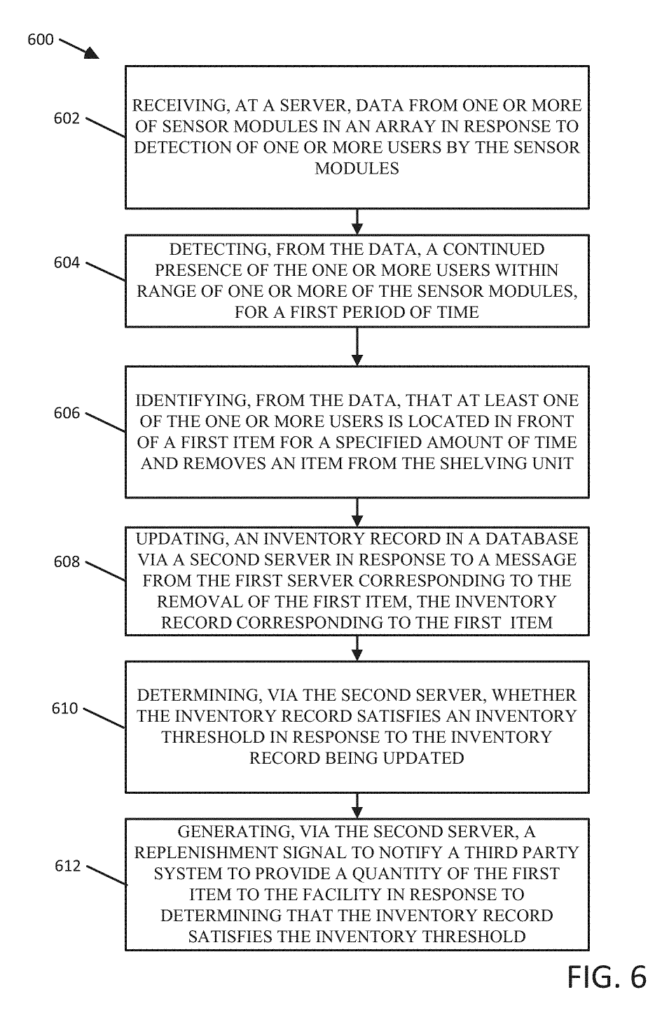

FIG. 6 is a flowchart illustrating a process for updating inventory records according to an exemplary embodiment.

At step 602, sensing data can be received at a first server from one or more of sensor modules in an array in response to detection of one or more users by the one or more of the sensor modules. The sensing data can be transmitted over a wired or wireless connection or through standard networking infrastructure. Alternatively, the sensing data can be received at the server through mesh IoT networking infrastructure, including a Bluetooth low energy (LE) mesh network.

At step 604, a continued presence of the one or more users within range of one or more of the sensor modules, for a first period of time, can be detected from the sensing data. The server determines from the sensing data that one or more users are present in the vicinity of the sensor and related items. The sensing data can be optical in nature (e.g., an image), acoustic, or can take the form of weight values take from scales on which users transit.

At step 606, the first one of the sensor module can identify, from the sensing data, that at least one of the one or more users is located in front of a first item for a specified amount of time and removes the first item from the shelving unit. Similar to as described above, the sensing data can persist for a period greater than the specified amount of time, and the sensing elements can detect a change relative to their sensing methods (e.g., change in weight on a scale corresponding to an item being added to a cart).

At step 608, an inventory record in a database can be updated via a second server in response to a message from the first server corresponding to the removal of the first item, the inventory record corresponding to the first item. The second server can take the form of an inventory server. The inventory server facilitates the procurement of additional product stock. The inventory server monitors the stock of the items in store, as well as stock in the distribution centers, and peer retail stores. Additionally the inventory server can procure stock from the vendor of the items. The inventory server can determine a probability that the first item is viewed and ultimately removed from the facility. The inventory server can update the record corresponding to the item when the probability is determined to be greater than a threshold. Alternatively, the server can monitor the POS terminals to identify transactions corresponding to the item after the removal from the shelving unit. The server can determine whether the time between the users interest, and the removal satisfies a threshold, and then determine the shortest period of time between the continuous detection of the user within range of the sensor and the point of sale transaction.

At step 610, the second server can determine whether the inventory record satisfies an inventory threshold in response to the inventory record being updated. Once the inventory record is depleted of sufficient amount to sustain adequate stock, the inventory server can take action to remedy the stock.

At step 612, the second server can generate a replenishment signal to notify a third party system to provide a quantity of the first item to the facility in response to determining that the inventory record satisfies the inventory threshold. The inventory server can notify a peer store, distribution center or vendor to prepare an order of the item. The inventory threshold can be determined based in part on the capacity for transport of the items or a transport time.

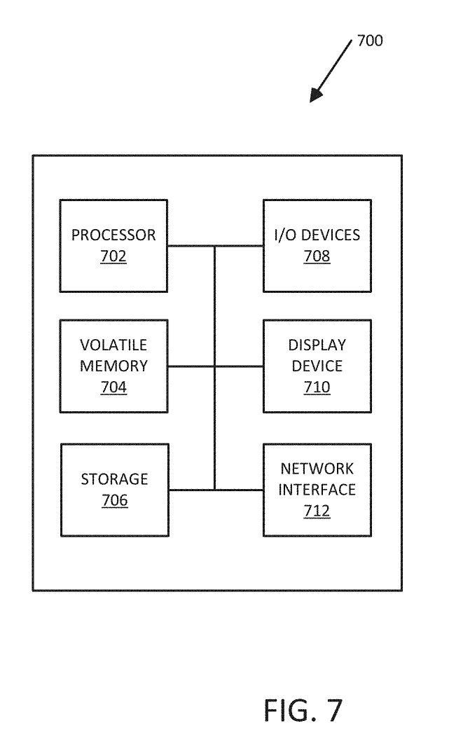

FIG. 7 is a block diagram illustrating an electronic device operable to support a system for inventory management according to an exemplary embodiment.

Computing device 700 process product scoring and inventory management. The computing device 700 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more flash drives, one or more solid state disks), and the like. For example, volatile memory 704 included in the computing device 700 can store computer-readable and computer-executable instructions or software for implementing exemplary operations of the computing device 700. The computing device 700 also includes configurable and/or programmable processor 702 for executing computer-readable and computer-executable instructions or software stored in the volatile memory 704 and other programs for implementing exemplary embodiments of the present disclosure. Processor 702 can be a single core processor or a multiple core processor. Processor 702 can be configured to execute one or more of the instructions described in connection with computing device 700.

Volatile memory 704 can include a computer system memory or random access memory, such as DRAM, SRAM, EDO RAM, and the like. Volatile memory 704 can include other types of memory as well, or combinations thereof.

A user can interact with the computing device 700 through a display 710, such as a computer monitor, which can display one or more graphical user interfaces supplemented by I/O devices 708, which can include a multi-touch interface, a pointing device, an image capturing device and a reader.

The computing device 700 can also include storage 706, such as a hard-drive, CD-ROM, or other computer-readable media, for storing data and computer-readable instructions and/or software that implement exemplary embodiments of the present disclosure (e.g., applications). For example, storage 706 can include one or more storage mechanisms for storing information associated with viewed and ultimately bought scores and latent attributes and can be indexed accordingly. The storage mechanism can be updated manually or automatically at any suitable time to add, delete, and/or update one or more data items in the databases 110A, 110B.

The computing device 700 can include a network interface 712 configured to interface via one or more network devices with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the network interface 712 can include one or more antennas to facilitate wireless communication between the computing device 700 and a network and/or between the computing device 700 and other computing devices. The network interface 712 can include a built-in network adapter, network interface card, PCMCIA network card, card bus network adapter, wireless network adapter, USB network adapter, modem or any other device suitable for interfacing the computing device 700 to any type of network capable of communication and performing the operations described herein.

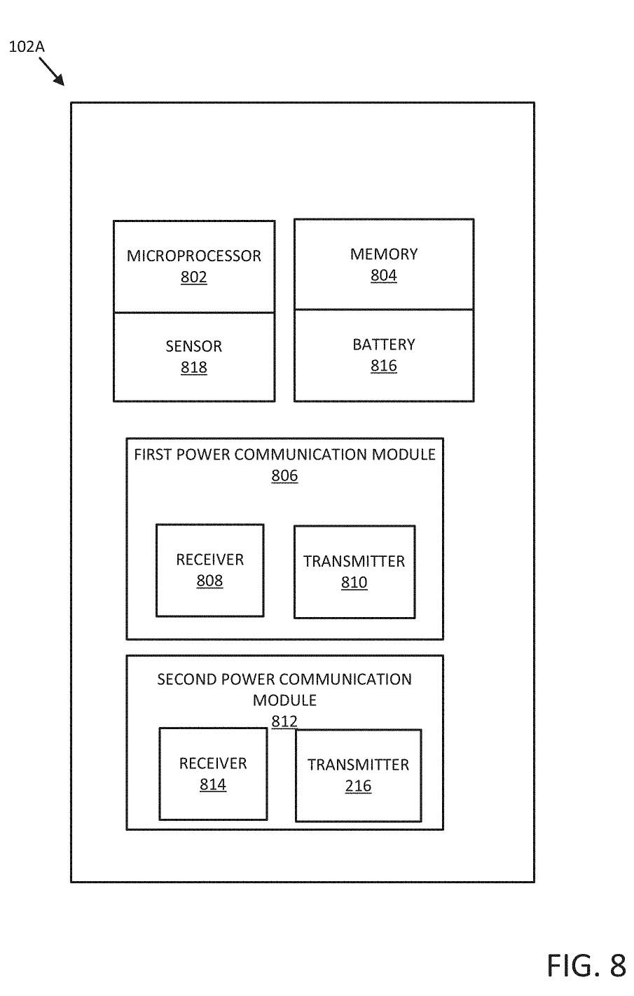

FIG. 8 is a block diagram of an example embodiment of the sensor module 102A to support the distributed sensor system according to an exemplary embodiment. Each sensor module in the array of sensor modules described herein can be implemented according to the example embodiment of the sensor module 102A. The sensor module 102A includes a microprocessor 802 communicatively coupled to a memory 804, a battery 816 to provide power to the sensor module 102A, a first power level (FPL) radiofrequency communication module 806, and a second power level (SPL) radiofrequency communication module 812. The FPL radiofrequency communication module 806 and the SPL radiofrequency communication module 812 are configured to transmit and receive data at different power levels to control a range of communication with the server 104 and other sensor module 102A, as described herein.

The FPL radiofrequency communication module 806 includes a receiver 808 configured to receive signals at a first power level via wireless communication transmitted from the server 104 via one or more wireless access points and convert the signals to electrical signals that can be read by the microprocessor 802. The FPL radiofrequency communication module 806 further includes a transmitter 810 configured to transmit signals at a first power level via wireless communication through one or more wireless access points to the server 104. In the example embodiment, the wireless communication between an electronic shelf label and the wireless access point(s) uses a Wi-Fi communication protocol with the first power level. In some embodiments, the receiver 808 and transmitter 810 are combined into a transceiver unit.

The SPL radiofrequency communication module 812 includes a receiver 814 configured to receive signals at a second power level via wireless communication transmitted from one or more of the sensor modules 102. The receiver 814 can convert the signals to electrical signals that can be read by the microprocessor 802. The SPL radiofrequency communication module 812 further includes a transmitter 816 configured to transmit signals at a second power level via wireless communication. The SPL radiofrequency communication module 812 is configured to transmit data at the second power level using at least one of low level Wi-Fi, Bluetooth, low energy Bluetooth, near field communication (NFC), or RFID capabilities. In an exemplary embodiment, the transmitter 816 can be configured to transmit signals at the second power level through RFID connections to one or more sensor modules 102A. In some embodiments, the receiver 814 and transmitter 816 are combined into a transceiver unit.

While the non-limiting example embodiment shown in FIG. 8 includes the first power level radiofrequency communication module 806 and the second power level communication module 812, exemplary embodiments of the electronic shelf labels can include a single communication module that is configured to selectively transmit data/information at the first power level and to selectively transmit data/information at the second power level. For example, in exemplary embodiments, a communication module of a sensor module 102A can be configured to selectively transmit data/information to the wireless access point(s) at the first power level and to selectively transmit data/information to other electronic shelf labels at the second power level. In some embodiments, the frequency at which the data/information is transmitted is identical for transmissions at the first and second power levels. In some embodiments, the frequency at which the data/information is transmitted is different for transmissions at the first and second power levels.

The sensor module 102A can further include at least one sensor 818 controlled by the microprocessor 802. For example, the sensor 818 may include optical sensors, acoustic sensors, weight sensors, radio-frequency identification (RFID), inductance sensors, capacitive sensors, cameras (e.g., CMOS imagers or CCD sensors). In one embodiment, the sensor module 102A includes a sensor driver, and the microprocessor 802 is arranged to control updates of the sensor 818 by controlling the sensor driver.

The microprocessor 802 of the sensor module 102A is configured to receive programming instruction from the server 104 or another one of the sensor modules to configure the sensor module 102A to detect activity in front of the sensor 818, such as a customer viewing a product on the shelf associated with the sensor module 102A. More particularly, the microprocessor 802 is configured to process the received programming instructions and relate the instructions to the operation of the sensor 818.

The sensor module 102A can operate in a sleep mode of operation, an intermediate mode of operation, and an active mode of operation. In the sleep mode of operation, the microprocessor 802 and communication module 806 are in a low power state (e.g., drawing micro-Amps), while the sensor 818 is operation to detect objects and the SPL communication module 812 is functional to receive messages from other sensor modules, but not to transmit messages. In the intermediate mode of operation, the microprocessor 802 and communication module 806 are in a low power state (e.g., drawing micro-Amps), while the sensor 818 is operating to detect objects and the communication module 812 is functional to transmit and receive messages. In the active mode of operation, each component of the sensor module 102A is fully operational/functional to perform the functions described herein with respect to the active mode.

The microprocessor 802 can operate in the sleep mode for an indefinite period of time, and can periodically transition to operate in an awake/active mode (activate from the sleep mode) to identify whether one of the sensor modules 102A has detected a consumer within sensing area. Alternatively, or in addition, an output of the sensor can be connected to the microprocessor, and a change in the output of the sensor can cause the microprocessor to transition to the active mode. The microprocessor can transition from the sleep mode of operation to the intermediate mode of operation in response to an adjacent/neighboring sensor module detecting an object/user and transmitting a message to the sensor module, which can be received via the SPL communication module 812, which can receive the message and output it to the microprocessor.

When the sensor module 102A is in the sleep mode operation, and the sensor 818 detects an object/user, the microprocessor transitions from the sleep mode to the active mode. In response to transitioning to the active mode, the microprocessor can control the SPL communication module 812 to transmit a message at the second power level to other adjacent or neighboring sensor modules (e.g., as defined by those sensor modules within range of the transmission from the communication module 812 at the second power level or those sensor modules having specified addresses/identifiers). The neighboring/adjacent sensor modules can receive the message and transition from the sleep mode to the intermediate mode. When in an active mode, the microprocessor 802 controls the communication channels, for example, by controlling when to send transmissions to other sensor modules 102A and receive data from the server 104 including data for other sensor modules. In this way, sufficient processor capacity is available when needed, for example, for information updates. At the same time, since the microprocessor 802 is only active and consuming power when it is needed (e.g., to discharge the duties of an actively detecting sensor), excess or unnecessary power consumption is minimized. After a predefined period of time or after the sensor module no longer detects a consumer, the microprocessor 802 returns to sleep mode and power consumption will be reduced.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes multiple system elements, device components or method steps, those elements, components, or steps can be replaced with a single element, component, or step Likewise, a single element, component, or step can be replaced with multiple elements, components, or steps that serve the same purpose. Moreover, while exemplary embodiments have been shown and described with references to particular embodiments thereof, those of ordinary skill in the art will understand that various substitutions and alterations in form and detail can be made therein without departing from the scope of the present disclosure. Further, still, other aspects, functions, and advantages are also within the scope of the present disclosure.

Exemplary flowcharts are provided herein for illustrative purposes and are non-limiting examples of methods. One of ordinary skill in the art will recognize that exemplary methods can include more or fewer steps than those illustrated in the exemplary flowcharts and that the steps in the exemplary flowcharts can be performed in a different order than the order shown in the illustrative flowcharts.

We claim:

1. A method in a distributed sensor system comprising:
controlling an array of sensor modules distributed along a shelving unit in a facility according to a first operation mode by default in which recordation of sensor data acquired by a sensing element in each of the sensor modules is disabled and a wireless transmitter in each of the sensor modules is disabled;
in response to detection of a first user within range of a first one of the sensor modules, transitioning the first one of the sensor modules in the array from the first operation mode to a second operation mode in which recordation of the sensing data acquired by the sensing element is enabled and the wireless transmitter is enabled;
transmitting a first message from the first one of the sensor modules to a server in selective communication with the sensor modules, the server configured to receive the first message from the first one of the sensor modules and to transmit a threshold time to the first one of the sensor modules based on receipt of the first message;
transmitting a second message from the first one of the sensor modules to one or more of the sensor modules in the array that are located adjacent to the first one of the sensor modules upon transitioning to the second mode of operation;
in response to receipt of the second message, transitioning the one or more sensor modules in the array located adjacent to the first one to a third operation mode in which recordation of sensing data is enabled in the one or more sensor modules and the wireless transmitter is disabled;
in response to continuous detection of the first user within range of the first one of the sensor modules for a period of time greater than the threshold time, transmitting the sensing data from the first one of the sensor modules to the server; and
in response to continuous detection of the first user within range of the first one of the sensor modules for a period of time less than the threshold time, reverting the first one of the sensor modules back to the first operation mode.

2. The method of claim 1, wherein the first one of the sensor modules continuously detects the first user within range of the first one of the sensor modules for a period of time greater than the threshold time and the method further comprises:
identifying, from the sensing data, that the first user removes at least one of the one or more items from the shelving unit;
calculating a preference score for each item using the sensing data and whether the first user removes the item from the shelving unit; and
based on the preference score, providing a recommendation to a second user for at least one of the items.

3. The method of claim 2, further comprising extracting from the sensing data the threshold time associated with the one or more items.

4. The method of claim 2, wherein the preference score includes a viewed and ultimately bought (VUB) score.

5. The method of claim 2, wherein the preference score includes an item similarity score for one or more items with respect to the item removed from the shelving unit.

6. The method of claim 2, wherein the recommendation includes at least one of replacing a low-performing item with a different item, rearranging locations of items on the shelving unit, or changing pricing information for an item.

7. The method of claim 1, wherein each sensing element includes at least one of an imaging device, a weight sensor, a radio-frequency identification sensor, or an infrared sensor.

8. The method of claim 1, wherein the wireless transmitter comprises a near-field communications transmitter.

9. The method of claim 1, wherein a spacing between sensor modules on the shelving unit is determined by an average dimension of items in a category corresponding to the items.

10. The method of claim 2, further comprising performing a key attribute analysis by generating a classification model based upon the sensing data for each item to determine key driver attributes.

11. The method of claim 1, further comprising:
in response to detection of the first user transitioning within range of at least one of the one or more sensor modules adjacent to the first one of the sensor modules, transitioning the at least one of the one or more sensor modules adjacent to the first one of the sensor modules from the third operation mode to the second operation mode;
transmitting a third message from the at least one of the one or more sensor modules to the server, the server configured to receive the third message from the at least one of the one or more sensor modules and to transmit a threshold time to the at least one of the one or more sensor modules based on receipt of the third message;
transmitting a fourth message from the at least one of the one or more sensor modules to the first one of the sensor modules upon transitioning to the second mode of operation;
in response to receipt of the fourth message, transitioning the first one of the sensor modules to the third operation mode in which recordation of sensing data is enabled in the first one of the sensor modules and the wireless transmitter is disabled.

12. A distributed sensor system comprising:
an array of sensor modules distributed along a shelving unit in a facility, each of the sensor modules operate according to a first operation mode by default in which recordation of sensor data acquired by a sensing element in each of the sensor modules is disabled and a wireless transmitter in each of the sensor modules is disabled;
a server in selective communication with the sensor modules, the server configured to receive sensing data from the sensor modules and transmit a threshold time to the sensor modules based on receipt of the sensing data;
a first one of the sensor modules in the array is configured to transition from the first operation mode to a second operation mode in which recordation of the sensing data acquired by the sensing element is enabled and the wireless transmitter is enabled in response to detection of a first user within range of the first one of the sensor modules, the first one of the sensing modules transmits a first message to the server and transmits a second message to one or more of the sensing modules in the array that are located adjacent to the first one of the sensor modules upon transitioning to the second mode of operation;
wherein the one or more sensor modules in the array that are located adjacent to the first one of the sensor modules transition from the first operation mode to a third operation mode in response to receipt of the second message in which recordation of sensing data is enabled in the one or more sensor modules and the wireless transmitter is disabled, and
wherein the first one of the sensor modules transmits the sensing data to the server upon continuous detection of the first user within range of the first one of the sensor modules for a period of time that is greater than the threshold time or reverts back to the first operation mode upon detection of the user within range of the first one of the sensor modules for a period of time that is less than the threshold time.

13. The system of claim 12, wherein a processor of the server is configured to execute instructions to:
identify, from the sensing data, that the first user removes at least one of the one or more items from the shelving unit;
calculate a preference score for each item using the sensing data and whether the first user removes the item from the shelving unit; and
based on the preference score, provide a recommendation to a second user for at least one of the items.

14. The system of claim 13, wherein the processor is further configured to execute instructions to extract from the sensing data the threshold time associated with the one or more items.

15. The system of claim 13, wherein the preference score includes a viewed and ultimately bought (VUB) score.

16. The system of claim 13, wherein the preference score includes an item similarity score for one or more items with respect to the item removed from the shelving unit.

17. The system of claim 13, wherein the recommendation includes at least one of replacing a low-performing item with a different item, rearranging the location of items on the shelving unit, or changing pricing information for an item.

18. The system of claim 12, wherein each sensing element includes at least one of an imaging device, a weight sensor, a radio-frequency identification sensor, or an infrared sensor.

19. The system of claim 12, wherein the wireless transmitter comprises a near-field communications transmitter.

20. The system of claim 12, wherein a spacing between sensor modules on the shelving unit is determined by an average dimension of items in a category corresponding to the items.

21. The system of claim 13, wherein the processor is further configured to execute instructions to:
perform a key attribute analysis by generating a classification model based upon the sensing data for each item to determine key driver attributes.

22. The system of claim 12, wherein, in response to detection of the first user transitioning within range of at least one of the one or more sensor modules adjacent to the first one of the sensor modules, the at least one of the one or more sensor modules adjacent to the first one of the sensor modules transitions from the third operation mode to the second operation mode;
wherein a third message is transmitted from the at least one of the one or more sensor modules to the server, the server configured to receive the third message from the at least one of the one or more sensor modules and to transmit a threshold time to the at least one of the one or more sensor modules based on receipt of the third message;
wherein a fourth message is transmitted from the at least one of the one or more sensor modules to the first one of the sensor modules upon the at least one of the one or more sensor modules transitioning to the second mode of operation; and
wherein, in response to receipt of the fourth message, the first one of the sensor modules transitions to the third operation mode in which recordation of sensing data is enabled in the first one of the sensor modules and the wireless transmitter is disabled.
